(19) United States
(12) Patent Application Publication
(10) Pub. No.: US 2011/0293295 A1
(43) Pub. Date: Dec. 1, 2011

(54) IMAGE FORMING APPARATUS

(75) Inventor: Seiichi Shinohara, Mishima-shi (JP)

(73) Assignee: CANON KABUSHIKI KAISHA, Tokyo (JP)

(21) Appl. No.: 13/115,374

(22) Filed: May 25, 2011

(30) Foreign Application Priority Data
May 26, 2010 (JP) 2010-120679(PAT)
May 12, 2011 (JP) 2011-107397(PAT)

(51) Int. Cl. G03G 15/00; G03G 15/08

(52) U.S. Cl. 399/24; 399/25; 399/26; 399/27

(57) ABSTRACT

An image forming apparatus includes a first unit including means contributable to image formation; a second unit constituting a pair with the first unit and including means contributable to the image formation; a detecting device for detecting a degree of use of each of the first unit and the second unit, wherein limits of usability are predetermined for the first unit and the second unit, respectively; and a control device capable of outputting information signals for notifying states near the limits of usability on the basis of preset thresholds of degrees of use, respectively, wherein a number of capable image formations from an output of the signal indicating the near state for the first unit to the limit of usability of the first unit is larger than a number of capable image formations from an output of the signal indicating the near state for said second unit to the limit of usability of the second unit, and wherein the control device outputs the signal for the second unit when the degree of the second unit reaches a second threshold of degree, and the control device outputs the signal for the first unit when a condition that the degree of the first unit reaches a first threshold of degree of the first unit and a condition that the degree of the second unit reaches a second threshold of degree are satisfied.

### FIELD OF THE INVENTION AND RELATED ART

The present invention relates to an image forming apparatus.

There have been known various color image forming apparatuses which form a multicolor image on recording medium such as a sheet of paper. Among those color image forming apparatuses, some of them are known as a color image forming apparatus of the tandem type. One of the characteristic features of a color image forming apparatus of the tandem type is as follows: It has four image forming stations for forming yellow, magenta, cyan, and black monochromatic images, one for one. The four image forming stations are sequentially arranged in parallel to each other. Each image forming station has a latent image formation unit and a development unit. The latent image formation unit has an image bearing member, on which an electrostatic latent image is formed, whereas the development unit is for developing the electrostatic latent image. Further, a color image forming apparatus of the tandem type forms a multicolor image by placing in layers four monochromatic images formed different in color by the four image forming stations one for one. A color image forming apparatus of the tandem type can form not only a multicolor image, but also, a monochromatic (black in particular) image. Thus, it is used for forming only a black-and-white image by a large number of users. Therefore, it is usually designed so that not only can it be operated in the “full-color mode”, but also, in the “black monochromatic mode”, which uses only the latent image formation unit for black color, and the development unit for black color.

The latent image formation unit and development unit of a color image forming apparatus of the tandem type are expendable supplies. Thus, as they reach their end of service life, they have to be replaced. Therefore, it is common practice to integrate a latent image formation unit and a development unit into a process cartridge, which is removably mountable in the main assembly of a color image forming apparatus of the tandem type, in order to make it easier to replace the latent image formation unit and development unit, that is, the expendable supplies.

Generally speaking, a latent image formation unit and a development unit are different in the total length of time they can be used (life expectancy) if they are the same in the condition under which they are used. That is, the length of time the latent image formation unit can be used before it reaches the end of its service life is affected by the state of wear of its image bearing member, whereas the length of time a development unit can used before it reaches the end of its service life is determined by the rate of consumption of the developer therein. Further, the state of wear of the image bearing member of a latent image formation unit, and the rate of consumption of the developer in a development unit, are affected by: the ratio between the color and black (black-and-white) modes; whether only a single copy is made per image forming operation, or multiple copies are continuously made per image forming operation; “image ratio”, which is equivalent to the amount of developer consumption per copy; and/or the like. They are also affected by how the apparatus is used by an operator. Therefore, in a case where a latent image formation unit and a development unit are integrally placed in a cartridge (process cartridge shell), the two units have to be replaced together. That is, if one of the units reaches the end of its service life, the other unit is going to be replaced along with the unit which has reached the end of its service life, even if it has not reached the end of its service life.

Thus, it has been proposed to divide a process cartridge, such as the one described above, into two independent process cartridges, that is, a latent image formation process cartridge comprising a latent image formation unit, and a development process cartridge comprising a development unit, and also, to design a color image forming apparatus of the tandem type, which is compatible with a latent image formation process cartridge and a development process cartridge (Japanese Laid-open Patent Application 2004-279689. This proposal makes it possible to efficiently use both a latent image formation unit (latent image formation process cartridge) and a development unit (development process cartridge) until they reach the end of their own official life expectancy, eliminating thereby the aforementioned waste.

However, a color image forming apparatus, and a combination of a latent image formation process cassette and a development process cartridge, which is used by the image forming apparatus, suffer from the following problems.

That is, in the case of an image forming apparatus which employs a process cartridge, it is a common practice for a user to be prompted to prepare a replacement process cartridge. That is, the remaining length of the service life of the process cartridge in the image forming apparatus is continuously monitored to inform the user of the imminent ending of the service life of the process cartridge before it is detected that the service life of the process cartridge in the image forming apparatus has ended. With this practice, as the service life of a process cartridge in the image forming apparatus ends, a user can immediately replace the cartridge to continue the on-going printing operation with virtually no interruption, that is, virtually no reduction in productivity.

However, an image forming apparatus structured to employ a latent image formation process cartridge and a development unit process cartridge, in stead of a process cartridge comprising both a latent image formation unit and a development unit has the following problems. That is, it is greater in the number of the process cartridges which need to be replaced, being therefore greater in the frequency with which the warning is issued to inform a user that the service life of the process cartridge(s) in the image forming apparatus is about to end. Therefore, it is greater in the number of times a user is required to prepare a replacement cartridge(s). This creates a serious problem, because in recent years, it has become common practice for peripheral apparatuses, such as an image forming apparatus, to be shared by a large number of users which are on the network to which the peripherals are connected, and therefore, the reduction in the productivity of the peripheral apparatuses (image forming apparatus) has come to be a serious problem.

These problems arise from the fact that the service lives of the latent image forming unit and the developing unit are different from each other. The service lives are different depending on the use conditions such as image formation modes. For this reason, it has been difficult to avoid the problems. In addition, even when the service life of the latent image forming unit is much longer than that of the developing unit, irrespective of the use conditions. The repeated exchange of the developing unit brings about the latent image forming unit exchange timing.

### SUMMARY OF THE INVENTION

Thus, the primary object of the present invention is to provide an image forming apparatus which is significantly smaller in the amount of time and labor required for process cartridge replacement, in particular, the time and labor required to prepare a replacement process cartridge, being therefore, significantly smaller in the amount of the productivity reduction attributable to the temporary interruption of an on-going image forming operation attributable to process cartridge replacement, than any image forming apparatus in accordance with the prior art.

According to an aspect of the present invention, there is provided an image forming apparatus comprising a main assembly; a first unit detachably mountable to said main assembly and including means contributable to image formation; a second unit constituting a pair with said first unit and including means contributable to the image formation, said second unit being detachably mountable to said main assembly; a detecting device for detecting a degree of use of each of said first unit and said second unit, wherein limits of usability are predetermined for said first unit and said second unit, respectively; and a control device capable of outputting information signals for notifying states near the limits of usability on the basis of preset thresholds of degrees of use, respectively, wherein when image formations are carries out under a predetermined image forming condition, a number of capable image formations from an output of the information signal indicating the near state for said first unit to the limit of usability of said first unit is larger than a number of capable image formations from an output of the information signal indicating the near state for said second unit to the limit of usability of said second unit, and wherein said control device outputs the information signal for said second unit when the degree of use of said second unit reaches a second threshold of degree of use, and said control device outputs the information signal for said first unit when a condition that the degree of use of said first unit reaches a first threshold of degree of use of said first unit and a condition that the degree of use of said second unit reaches a second threshold of degree of use are satisfied.

According to another aspect of the present invention, there is provided an image forming apparatus comprising a main assembly; a first unit detachably mountable to said main assembly and including a device contributable to image formation; a second unit constituting a pair with said first unit and including a device contributable to the image formation, said second unit being detachably mountable to said main assembly; a detecting device for detecting a degree of use of each of said first unit and said second unit, wherein limits of usability are predetermined for said first unit and said second unit, respectively; and a control device capable of outputting information signals for notifying states near the limits of usability on the basis of degrees of use, respectively, wherein when image formations are carries out under a predetermined image forming condition, a number of capable image formations from an output of the information signal indicating the near state for said first unit to the limit of usability of said first unit is larger than a number of capable image formations from an output of the information signal indicating the near state for said second unit to the limit of usability of said second unit, and wherein said control device changes timing of outputting the information signal for said first unit, in accordance with the degree of use of said second unit.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of the image forming apparatus of the tandem type, in the first preferred embodiment of the present invention, and shows the general structure of the apparatus.

FIG. 2 is a schematic sectional view of the process cartridge which is removably mountable in the color image forming apparatus shown in FIG. 1.

FIG. 3 is a flowchart, in the first preferred embodiment, of the operational sequence for issuing a warning that informs a user of the imminent ending of the service life of the process cartridge in the image forming apparatus, and the warning for informing a user that the service life of the process cartridge has ended.

FIG. 4 is a flowchart, in the second preferred embodiment, of the operational sequence for issuing a warning that informs a user of the imminent ending of the service life of the process cartridge in the image forming apparatus, and the warning for informing a user that the service life of the process cartridge has ended.

### DESCRIPTION OF THE PREFERRED EMBODIMENTS

Hereinafter, the present invention is described in detail with reference to the preferred embodiments of the present invention and appended drawings. The measurements, materials, and shapes of the structural components of the image forming apparatus and process cartridges, and the positional relationship among the structural components, in the following preferred embodiments of the present invention, are not intended to limit the present invention in scope, unless specifically noted.

### Embodiment 1

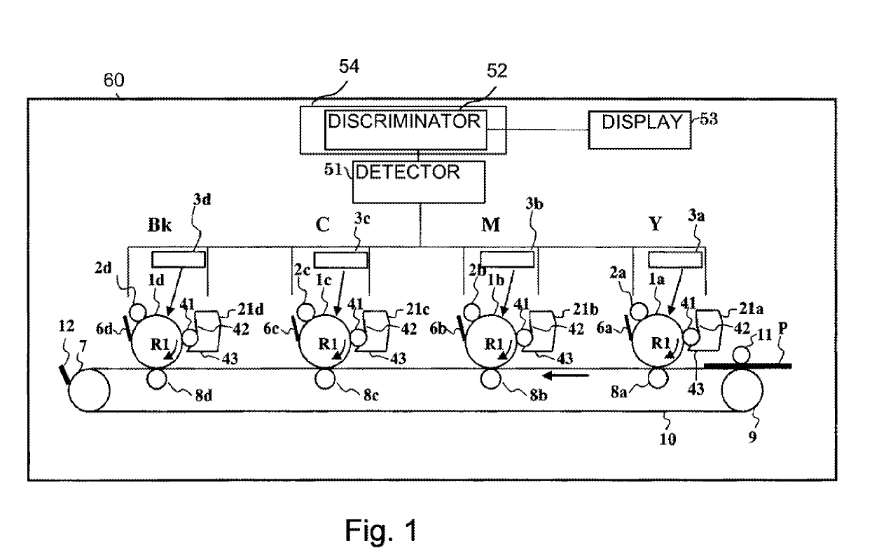

First, referring to FIG. 1, the image forming apparatus in the first preferred embodiment, that is, an example of a color image forming apparatus in accordance with the present invention, is described about its structure. The image forming apparatus 60 shown in FIG. 1 is of the so-called tandem type. That is, the image forming apparatus 60 has four processing stations Y, M, C, and Bk, which are first, second, third, and fourth image forming means for forming yellow (Y), magenta (M), cyan (C), and black (Bk) monochromatic images, respectively. The four processing stations Y, M, C, and Bk are independent from each other. The image forming apparatus 60 has also a transfer belt 10, that is, a transfer medium bearing member for conveying a sheet P of recording medium. The four processing stations are sequentially arranged in parallel in the moving direction (circular movement indicated by arrow mark; left to right in drawing) of the transfer belt 10, with the processing station Y being the most upstream one. As four monochromatic images, different in color, formed in the first to fourth processing stations Y, M, C, and Bk, one for one, are sequentially transferred onto the sheet P of recording medium, which is being conveyed by the transfer belt 10 while remaining adhered to the belt 10, a full-color image, which is based on four primary colors, is formed on the sheet P of recording medium.

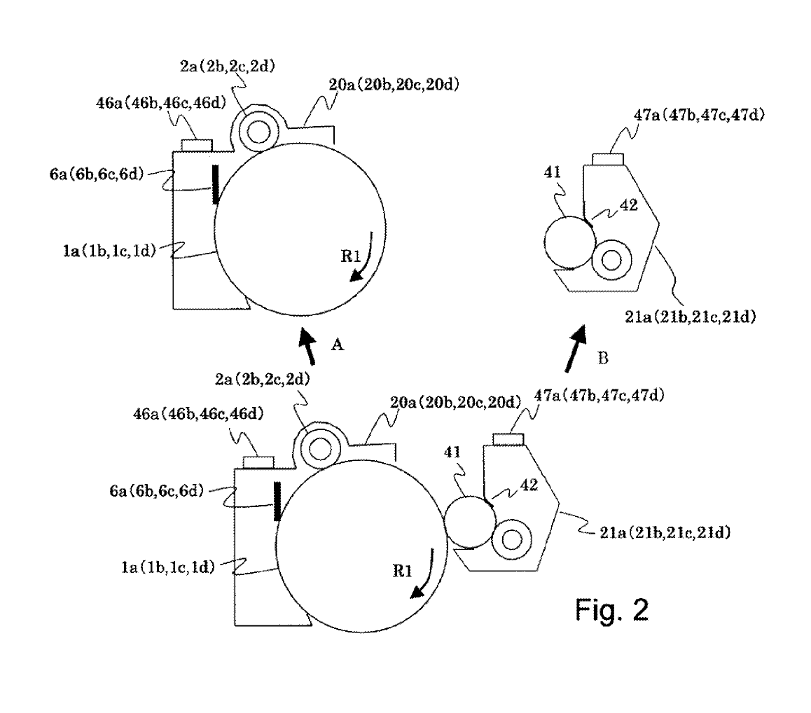

Next, referring to FIG. 2, in order to improve the image forming apparatus 60 in maintainability, the apparatus 60 is structured so that latent image formation process cartridges 20 (20a-20d) are removably mountable in the processing stations Y, M, C, and Bk, respectively, of the main assembly of the apparatus, independently from each other, and also, so that development process cartridges 21 (21a-21d) also are removably mountable in the processing stations Y, M, C, and Bk, respectively, of the main assembly of the apparatus, independently from each other. The main assembly of the image forming apparatus 60 means the image forming apparatus 60 minus the latent image formation process cartridges 20a-20d and the development process cartridges 21a-21d. Hereafter, the latent image formation process cartridges 20a-20d may be referred to as a latent image unit or first unit, whereas the development process cartridge 21a-21d may be referred to as a development unit or second unit. The first units are removably mountable in the main assembly of the image forming apparatus 60 (which hereafter may be referred to simply as apparatus main assembly) in the direction indicated by an arrow mark A in FIG. 2, whereas the second units are removably mountable in the apparatus main assembly in the direction indicated by an arrow mark B in FIG. 2. The latent image formation process cartridges 20 (20a-20d) have: photosensitive drums 1a-1d as a member by which an electrostatic latent image is borne; charge rollers 2 (2a-2d) as a first charging means; cleaning blades 6 (6a-6d); information storage mediums 46 (46a-46d); etc., which are integrally disposed in a cartridge (shell of process cartridge). As for the development process cartridge 21 (21a-21d), they have: a developer container 43 in which developer is stored; a development roller 41; a blade 42 for controlling the thickness to which developer is to be coated on the development roller; information storage mediums 47a-47d; etc., which are integrally disposed in a cartridge (shell of process cartridge).

Each of the photosensitive drums 1 (1a-1d) in this embodiment is a photosensitive drum made up of a negatively chargeable OPC (organic photoconductive semiconductor). It is 30 mm in diameter. During an image forming operation, it is rotated in the direction indicated by an arrow mark R1 at peripheral velocity (process speed) of 100 mm/sec.

The image forming apparatus 60 has also: first charging devices 2 (2a-2d), exposing devices 3 (3a-3d), development process cartridges 21 (21a-21d), transferring member 8 (8a-8d), and cleaning blades 6 (6a-6d) (electrostatic cleaning member for cleaning electrostatic latent image bearing member), which are in the adjacencies of the photosensitive drums 1 (1a-1d), respectively.

As the photosensitive drums 1 (1a-1d) are rotated in the direction indicated by the arrow mark R1, they are uniformly charged to preset polarity and potential level by the first charge rollers 2 (2a-2d), which are first charging devices. Then, they are exposed by the exposing devices 3 (3a-3d), respectively. Consequently, four electrostatic latent images, which correspond, one for one, to the first to fourth primary color components of a color image to be formed, are formed on the photosensitive drums 1 (1a-1d), one for one. Each of the first charge rollers 2 (2a-2d) is 1×10Ω in electrical resistance when −1.2 kV of DC voltage is applied. The charge rollers 2 (2a-2d) are kept pressed upon the corresponding photosensitive drums 1 (1a-1d) so that a total pressure of 9.8 N (Newton) is maintained between the corresponding photosensitive drum 1 and charge roller 2. Thus, the charge rollers 2 (2a-2d) are rotated by the rotation of the photosensitive drums 1 (1a-1d), respectively. As a preset amount of voltage is applied to the first charge rollers 2 (2a-2d), the peripheral surface of each photosensitive drum 1 (1a-1d) is charged to −600 V.

Each of the exposing devices 3 (3a-3d) in this embodiment is a so-called polygon scanner which comprises a laser diode and a polygonal mirror. It forms an electrostatic latent image on the peripheral surface of the photosensitive drum 1 (1a-1d) by scanning the peripheral surface of the photosensitive drum 1 with a beam of laser light which it projects while modulating the beam with image formation signals. As the peripheral surface of the photosensitive drum 1 is exposed, that is, as a given point of the uniformly charged portions of the peripheral surface of the photosensitive drum 1 is illuminated with the beam of laser light, the electrical charge of this point reduces to −200 V. The writing of an electrostatic latent image by the beam of laser light in the primary direction of scanning (direction perpendicular to transfer medium advancement direction) is controlled per scan line by the coordinate signals (which are referred to as BD), in the polygon scanner. As for the scanning in the secondary scanning direction (direction parallel to transfer medium advancement direction), it is carried out with a preset length of delay from a TOP signals generated by a switch (unshown) in the transfer conveyance passage. Thus, the photosensitive drums 1 (1a-1d) remain synchronized in terms of the point of exposure in the first to fourth processing stations Y, M, C, and Bk.

Then, the electrostatic latent images on the photosensitive drums 1 (1a-1d) are developed by the development process cartridges 21 (21a-21d), in the first to fourth processing stations Y, M, C, and Bk, respectively. Each development process cartridges 21 has a development roller 41, which is an elastic roller as a developer bearing member. The development roller 41 is positioned so that it is partially exposed from the development cartridge 21 and partially faces inward of the development cartridge 21, and also, so that it is in contact with the peripheral surface of the photosensitive drum 1. The development cartridge 21 develops the electrostatic latent image on the peripheral surface of the photosensitive drum 1 into a visible image (which hereafter will be referred to as toner image, since it is made of toner), by adhering toner to the electrostatic latent image with the use of its development roller 41; the development cartridges 21 (21a-21d) develop the electrostatic latent images on the photosensitive drums 1 (1a-1d) into visible images (made of yellow, magenta, cyan, and black monochromatic images), respectively. The developer in each development process cartridge 21 is nonmagnetic single-component toner, which is inherently negative in polarity. In this embodiment, an electrostatic latent image is developed by placing a layer of the nonmagnetic single-component toner, in contact with the peripheral surface of the photosensitive drum, on which the latent image is present. As the developer in each development process cartridge 21 is borne on the development roller 41 in the development process cartridge 21, it is formed into a developer layer, which is uniform in thickness, by a blade 42 as the means for regulating the developer layer in thickness. The blade 42 is outside the external shell of the development process cartridge 21, and is positioned on the upstream side of where an electrostatic latent image is developed, in terms of the rotational direction of the development roller 41.

Each development roller 41 is rotated at a preset process speed, which in this embodiment is 170% of the process speed of the photosensitive drum 1, in such a direction that its peripheral surface moves in the same direction as the peripheral surface of the corresponding photosensitive drum 1, in the interface between the peripheral surfaces of the development roller 41 and photosensitive drum 1. The electrostatic latent image on the peripheral surface of the photosensitive drum 1 is developed by applying a development bias (which is −350 V in this embodiment) to the development roller 41. Incidentally, the development bias is modifiable by a signal from a controller.

The transfer belt 10, by which a sheet P of recording medium is borne, is suspended and kept stretched by a driver roller 7 and a follower roller 9, and is circularly moved by the counterclockwise rotation of the driver roller 7, in the direction indicated by an arrow mark in FIG. 1, at a process speed which is the same as the process speed of the photosensitive drum 1. The transfer belt 10 is a single-layer endless belt formed of polyimide resin. It is 1×10¹⁰ Ω·cm in electrical resistance, and 100 μ in thickness. Both of its lengthwise edges are provided with a rib for preventing the transfer belt 10 from snaking and/or deviating in position in its widthwise direction. Designated by a referential numeral 12 is a cleaning blade for cleaning the transfer belt 10.

Each of the transfer rollers 8 (8a-8d), which is a toner image transferring member, is 1×10⁵ Ω·cm in volumetric resistivity. It keeps the transfer belt 10 pressed on the peripheral surface of photosensitive drum 1 by pressing the transfer belt 10 from the inward side of the loop which the transfer belt 10 forms. The four toner images on the photosensitive drums 1 (1a-1d), one for one, are sequentially transferred onto the sheet P of recording medium, by the application of transfer bias to the transfer rollers 8 (8a-8d) from a transfer bias power source (unshown).

Cleaning blades 6 (6a-6d), which are means for cleaning the photosensitive drums 1 (1a-1d), remove transfer residual toner, that is, the toner which failed to be transferred onto the sheet P of recording medium and is remaining on the peripheral surface of the photosensitive drums 1 (1a-1d), respectively. They remove also the reverse transfer toner, that is, the toner which was transferred back onto the peripheral surface of the photosensitive drums 1 from the sheet P of transfer medium, after being transferred onto the sheet P of recording medium.

The image forming apparatus 60 structured as described above employs a sheet feeder cassette (unshown) in which a substantial number of sheets P of recording medium are storable. The image forming apparatus 60 is structured so that the sheets P in the cassette are fed one by one into the apparatus main assembly, conveyed past a pair of registration rollers (unshown) and a transfer station entrance guide (unshown), and comes into contact with the transfer belt 10. In the case of an image forming apparatus structured as described above, the sheet P of recording medium has to be kept properly adhered to the transfer belt 10.

As described above, the sheet P of recording medium comes into contact with the transfer belt 10 after being conveyed past the transfer station entrance guide. Thus, the image forming apparatus 60 is provided with an adhesion roller 11, which is a member for adhering, and keeping adhered, the sheet P to the transfer belt 10. The adhesion roller 11 is in the adjacencies of the area of contact between the sheet P and transfer belt 10, in such a manner that the transfer belt 10 is sandwiched between the adhesion roller 11, and the follower roller 9, which is one of the two rollers by which the transfer belt 10 is suspended. During an image forming operation, +1 kV of voltage is continuously applied to the adhesion roller 11 to provide the sheet P with electric charge so that the sheet P remains electrostatically adhered to the transfer belt 10. That is, the sheet P is kept adhered to the surface of the transfer belt 10 by this electrostatic force generated by the voltage applied by the adhesion roller 11. The sheet P of recording medium is entered into the first process station Y while remaining adhered to the transfer belt 10 by the electrical charge (electrostatic attraction). Then, it is conveyed through the transfer area of the first process station Y. While the sheet P is conveyed through the transfer area, the toner image of yellow color (first color) is transferred onto the sheet P by the transfer roller 8a, which is on the opposite side of the transfer belt 10 from the photosensitive drum 1a. The transfer roller 8a in this embodiment is 1×10⁵ Ω·cm in electrical resistance. The nip between the transfer roller 8a and transfer belt 10 is 1.5 mm in dimension in terms of the direction (indicated by arrow mark) of the circular movement of the transfer belt 10. To the transfer roller 8a, +2 kV of DC bias is applied from a high voltage power source.

After the transfer of the yellow monochromatic toner image onto the sheet P of recording medium, the portion of the transfer belt 10, across which the sheet P of recording medium is kept adhered, is moved further in the direction indicated by the arrow mark. Thus, the sheet P is conveyed through the processing stations M, C, and Bk. As the sheet P is conveyed through the processing stations M, C, and Bk, the toner images, different in color, on the photosensitive drums 1b, 1c, and 1d, one for one, are transferred onto the sheet P. Consequently, four monochromatic toner images, different in color, are layered on the sheet P.

After the transfer of the four monochromatic toner images, different in color, onto the sheet P of recording medium, the sheet P is further conveyed by the transfer belt 10 to the downstream end (back end) of the transfer belt 10, at which it is separated from the transfer belt 10 by the curvature of the transfer belt 10. Then, the sheet P is conveyed through an unshown fixing device. As the sheet P is conveyed through the fixing device, the four monochromatic toner images, different in color, on the sheet P are fixed to the sheet P by the heat and pressure applied to the toner images by the fixing device. The fixation of the toner images to the sheet P ends the operation for forming a full-color image based on the four primary colors. Thereafter, the sheet P is discharged from the main assembly of the image forming apparatus 60.

In this embodiment, while each process cartridge (latent image formation process cartridge or development process cartridge) is mounted into, or removed from, the main assembly of the image forming apparatus 60, and also, at the end of the formation of each monochromatic image, information such as the color of the toner in the process cartridge which is being mounted or removed, and/or the extent of usage of the process cartridge, is read from, and/or written into, the information storage medium 46 (46a-46d) of the latent image formation process cartridge 20 (20a-20d), or the information storage medium 47 (47a-47d) of the development process cartridge 21 (21a-20d). Incidentally, NV-RAMs (Non-Volatile RAMs) which are 2 k bytes in storage capacity are used as the information storage medium 46 (46a-46d) and 47 (47a-47d). However, a magnetic information storage medium or an optical information storage medium may be used as the information storage mediums 46 and 47.

The image forming apparatus 60 has also: a detecting means 51, which detects the extent of usage of each process cartridge; a decision making means 52 which decides whether or not a process cartridge is at the end of its service life, or is near the end of its service life; and an information disseminating means 53 which outputs the decisions made by the decision making means 52. The CPU 54 (controlling means) of the image forming apparatus 60, which has the decision making means 52, decides whether or not the above described information (warnings) are to be outputted, based on the results of the detection by the detecting means 51. Then, it informs a user of its decision by transmitting the decision (information in the form of electric signals) to the information disseminating means 53 (warning means). The information disseminating means 53 is a liquid crystal display. The warning regarding the coming of the end of the service life of each process cartridge, and the warning regarding the imminent ending of the service life of each process cartridge, are displayed on the liquid display to inform the user of the information. Further, it is made possible for the estimated number of prints which can be made with the use of each process cartridge to be displayed as necessary, making it thereby possible for a user to predict the timing of the ending of the service life of each process cartridge.

The information disseminating means 53 may be a displaying means other than the liquid crystal display of the image forming apparatus 60. For example, it may be the display of a personal computer, which is in connection to the image forming apparatus 60, or the information regarding the image forming apparatus and each of the process cartridges 20 and 21 in the apparatus 60 may be printed out on the sheet P of recording medium.

Next, the method, in this embodiment, for detecting the extent of usage of the latent image formation process cartridge 20 (20a -20d) is described. In this embodiment, the extent of usage of each latent image formation process cartridge 20 (20a-20d) is determined (estimated) based on the cumulative number (length) of rotations of the photosensitive drum 1 (1a-1d). That is, it is assumed that as the cumulative length of time the photosensitive drum 1 in a latent image formation process cartridge 20 is rotated reaches the length of time the photosensitive drum 1 has to be rotated to print roughly 50,000 copies, the process cartridge reaches the end of its service life. In other words, the total length of time the photosensitive drum 1 (1a-1d) in a brand-new latent image formation process cartridge 20 was rotated since the cartridge 20 was used for the very first time reaches the length of time required to print roughly 50,000 prints, it is assumed that this latent image formation process cartridge has reached the end of its service life. That is, the life expectancy of the latent image formation process cartridge 20 in these conditions in this embodiment is roughly 50,000 prints.

Further, it is assumed that if the cumulative length of time the photosensitive drum 1 (1a-1d) in a given latent image formation process cartridge 20 is rotated exceeds the length of time necessary to yield roughly 40,000 prints, which is substantially less than 50,000, that is, the nominal life expectancy of the photosensitive drum 1, this latent image formation process cartridge 20 is near the end of its service life, and an end-of-service-life prewarning, that is, a warning that a process cartridge is near the end of its service life, is displayed. More concretely, the image forming apparatus 60 is provided with a preset threshold value (first usage threshold value) for informing a user that the cumulative length of time the photosensitive drum 1 in a given latent image formation process cartridge 20 has been used has reached a value equivalent to the length of time necessary to print 40,000 copies, that is, this latent image formation process cartridge is near the end of its service life. As for the extent of usage of the development process cartridge 21 (21a-21d), it is determined (estimated) based on the detected cumulative length of time the development roller in a given development process cartridge 21 has been rotated, and the optically detected amount of the toner in the development process cartridge 21. The optical means used, in this embodiment, for detecting the amount of toner in the development process cartridge 21 is one of the widely known means based on the conventional technologies. More specifically, the optical toner amount detecting means in this embodiment has a light emitting element and a light catching element, which are positioned so that the light beam path between the two elements crosses the toner storage portion of the development process cartridge 21 (21a-21d). It detects the amount of the toner in the development process cartridge 1, based on the phenomenon that the state of transmission of the beam of light projected from the light emitting element toward the light catching element, through the toner storage portion is affected by the amount of the developer in the developer storage portion. More specifically, if the amount by which the light catching element of a development process cartridge 20 receives for a preset length of time is no more than a preset value, it is assumed that there is a sufficient amount of toner in the development process cartridge 21, whereas if it is no less than the preset value, it is assumed that there is an insufficient amount of toner in the development process cartridge 21.

In this embodiment, it is assumed that after 5,000 copies, which are 2% in average image ratio, are printed with the use of a brand-new development process cartridge, the remaining length (which is virtually zero) of service life of this development process cartridge, which is predicted based on the cumulative length of time the development roller in the process cartridge has been rotated since the process cartridge was brand-new, equals the remaining length (which also is virtually zero) of service life of the same development process cartridge, which is predicted based on the optically detected amount of toner in the process cartridge. That is, the nominal life expectancy of the development process cartridge in this embodiment is 5,000 copies.

Further, the threshold value for determining whether or not a development process cartridge is near the end of its service life was set to 4,000 prints which are 2% in average image ratio. That is, it is assumed that as 4,000 copies, which are 2% in average image ratio, are printed with the use of a brand-new development process cartridge, the remaining length of service life of the development process cartridge becomes no more than 20% of the nominal life expectancy of the development process cartridge. Obviously, in a case where the average image ratio is higher than 20%, it is assumed that if the remaining length of service life of the development process cartridge predicted based on the optically detected amount of toner in the process cartridge becomes no more than 20%, the process cartridge is near the end of its service life, and also, that if the remaining length of service life of the development process cartridge predicted based on the optically detected amount of toner in the process cartridge becomes 0%, the process cartridge is at the end of its service life.

The image forming apparatus 60 is also provided with a preset threshold value (second usage threshold value) for outputting the signals for informing a user that a given development process cartridge is near the end of its service life, that is, a value for determining whether or not the development roller 41 (41a-41d) in the given development process cartridge 21 has been used to print 4,000 copies. Further, the image forming apparatus 60 is provided with a preset threshold value (second usage threshold value) for determining whether or not the remaining length of service life of a development process cartridge predicted based on the optically detected amount of toner in the development process cartridge has fallen below 20%. In the case of the image forming apparatus 60 in this embodiment, the development process cartridge is shorter in the nominal life expectancy than the latent image formation process cartridge. Here, the “nominal life expectancy” means the number of images which can be formed under a preset condition. Further, when the image forming operations are carried out under the predetermined conditions (print ratio and sheet size), the length of service life of a latent image formation process cartridge between the point at which it is determined that this process cartridge is near the end of its service life and the point at which this process cartridge reaches the end of the service life, is longer than the length of service life of a development process cartridge between the point at which this process cartridge is near the end of its service life and the point at which this process cartridge reaches the end of the service life. In this embodiment, the extent of usage of a latent image formation process cartridge and that of a development process cartridge are indicated by the ratio between the full and remaining lengths of service life of a brand-new latent image formation process cartridge and that of the development process cartridge, wherein it is 100% when a latent image formation process cartridge and a development process cartridge are brand-new, and 0% when they are at the end of their service life. The extent of usage of each of the latent image formation process cartridges and development process cartridges is recorded in the information storage medium 46 (46a-46d) of the latent image formation process cartridge 20 (20a-20d), and the information storage medium 47 (47a-47d) of each of the development process cartridges 21 (21a-21d) at the end of the formation of each image (print). Therefore, even if the electric power source of the main assembly of the image forming apparatus 60 is turned off, and/or the latent image formation process cartridge and/or development process cartridge in the main assembly of the image forming apparatus 60 is mounted in the main assembly of another image forming apparatus (60), the extent of usage of the latent image formation process cartridge and/or development process cartridge can be accurately detected in continuity. In this embodiment, the image forming apparatus 60 is set up so that the extent of usage of the latent image formation process cartridge and that of the development process cartridge are recorded in the information storage means 46 (46a-46d) of the latent image formation process cartridge 20 and the information storage means 47 (47a-47d) of the development process cartridge 21 after the formation of each image.

Next, the image forming apparatus in this embodiment of the present invention, and the effects of this embodiment, are described.

In the first preferred embodiment, whether or not a given latent image formation process cartridge is nearing the end of its service life is detected only when the remaining length of service life of the development process cartridge paired with the given latent image formation process cartridge is reduced to the point at which the CPU is to inform a user that the development process cartridge is nearing the end of its service life. That is, one of the characteristics of the first preferred embodiment of the present invention is that the timing with which a user is to be informed that a latent image formation process cartridge, as the second unit, is nearing the end of its service life is delayed according to the extent of usage of the corresponding development process cartridge as the first unit.

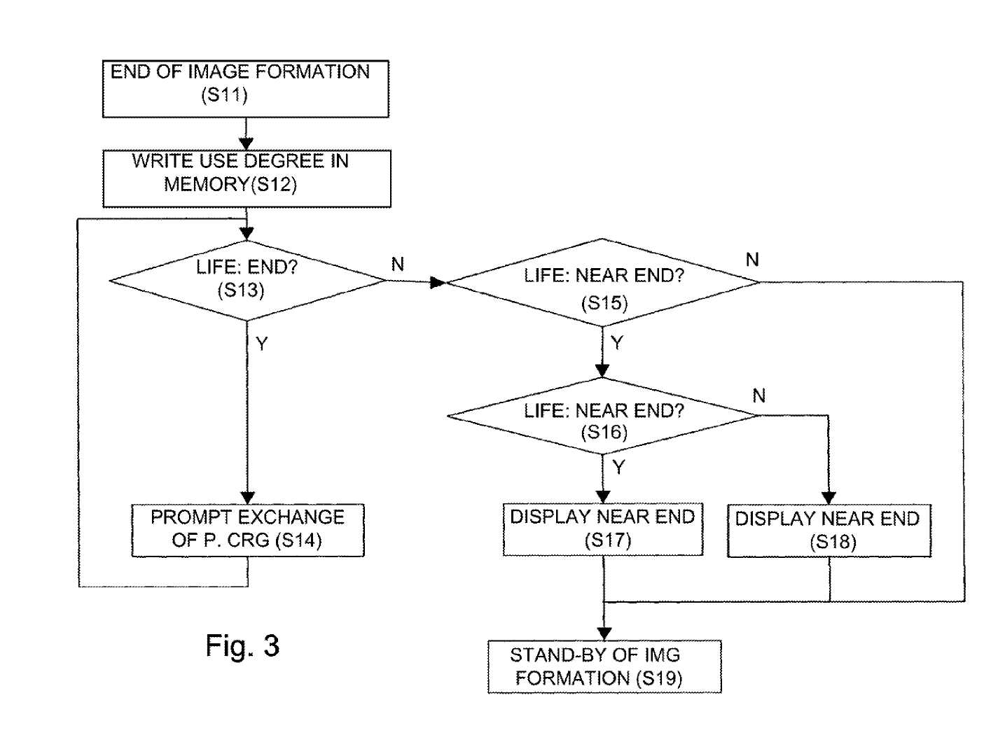

FIG. 3 shows the sequence of the operation for informing a user that a given latent image formation process cartridge and/or a given development process cartridge is at or near the end of its service life.

Referring to FIG. 3, at the end of the formation of each image by the image forming apparatus 60 (S11), the extent of usage of each of the latent image formation process cartridges 20 (20a-20d) and development process cartridges 21 (21a-21d) is written into the corresponding information storage means 46 (46a-46d) and 47 (47a-47d) (S12). Then, it is checked (first check) whether or not each of the latent image formation process cartridges 20 (20a-20d) and each of the development process cartridges 21 (21a-21d) has reached the end of its service life (S13). If it is determined that one or more of the process cartridges are at the end of their service life, a user is informed that one or more of the process cartridges need to be replaced (S14). If it is determined that no process cartridge has reached the end of its service life, it is checked (second check) whether or not the extent of usage of any of the development process cartridges 21 (21a-21d) has reached the threshold value for informing a user that one or more development process cartridges 21 are near the end of their service life (S15). If the answer is YES in (S15), it is checked (third check) whether or not the extent of usage of any of the latent image formation process cartridges 20 (20a-20d) has reached the threshold value for informing a user that one or more latent image formation process cartridges 20 are near the end of their service life (S16). Then, if the answer is YES in (S15) a user is informed of the development process cartridges 21 and latent image formation process cartridges 20 which are near the end of their service life (S17). If the answer is NO in (S15), a user is informed of only the development process cartridge or cartridges 20 which are near the end of their service life (S18). Then, the image forming apparatus 60 is prepared for image formation (S19). On the other hand, if it is determined in (S15) that none of the development process cartridges 20 is near the end of its service life, the image forming apparatus 60 is readied for image formation without being put through the above described steps (S19).

That is, the warning that any of the latent image formation process cartridges 20 is near the end of its service life is given with the warning that any of the development process cartridges 21 is near the end of its service life. In other words, even if any of the latent image formation process cartridges 20 is near the end of its service life, a user is not informed that the latent image formation process cartridge is near the end of its service life, unless it is necessary for the user to be informed that the corresponding development process cartridge is near the end of its service life.

As described previously, the life expectancy of a development process cartridge is generally shorter than that of a latent image formation process cartridge. In this embodiment, therefore, there is practically no chance that the warning that any of the latent image formation process cartridges is near the end of its service life is suddenly issued before the issuance of the warning that any of the development process cartridges is near the end of its service life. Further, in this embodiment, the number of prints which can be outputted before each process cartridge reaches the end of its service life can be known as necessary. Thus, a user can accurately predict the proper timing with which each process cartridge is to be replaced.

Therefore, even if there are a large number of removably mountable process cartridges in the main assembly of an image forming apparatus, the warning that one or more process cartridges are near the end of their service life is not going to be issued as often as it is in the case of any of the image forming apparatuses in accordance with the prior art. That is, the image forming apparatus in this embodiment is significantly lower in the frequency with which the operation for preparing replacement process cartridges, that is, an annoying operation to a user, has to carried out, than any of the image forming apparatuses in accordance with the prior art.

Incidentally, the above described operational sequence for issuing the warning that a process cartridge is near the end of its service life is related to only a combination of a latent image formation process cartridge and the corresponding development process cartridge, among the multiple latent image formation process cartridges and multiple development process cartridges in the main assembly of the image forming apparatus 60. That is, this embodiment is related to the combinations of the latent image formation process cartridges 20 (20a-20d) and development process cartridges 21 (21a-21d), respectively. Thus, the decision regarding whether or not the above described prewarning, that is, the warning that one or more process cartridges are near the end of their service life, made for the combination of the latent image formation process cartridge 20a and development process cartridge 20a, for example. That is, the decision is not made for the combination of the latent image formation process cartridge 20a and development process cartridge 21d.

### Embodiment 2

Next, the characteristics of the image forming apparatus in the second preferred embodiment of the present invention, and the effects of the application of the presence invention to the image forming apparatus, are described. The general structure of the image forming apparatus in this embodiment is virtually the same as that of the image forming apparatus in the first embodiment. That is, the image forming apparatus in this embodiment is different from the one in the first embodiment only in that it is provided with two threshold values (first and second values) for outputting the signals for informing a user that one or more latent image formation process cartridges in the main assembly of the image forming apparatus are near the end of their service lives. The first threshold value is used only when it is necessary to inform a user that one or more developing apparatuses in the apparatus main assembly are near the end of their service lives. Since the image forming apparatus in this embodiment is the same in structure as the image forming apparatus in the first embodiment, except for the structure of the latent image formation process cartridge, the structure of the apparatus main assembly and the structure of the development process cartridge are not described.

In this embodiment, the extent of usage of the latent image formation process cartridge 20 (20a-20d) is estimated based on the cumulative length of rotation of the photosensitive drum 1 (photosensitive drums 1a-1d). More specifically, it is assumed that as the photosensitive drum 1 in a given latent image formation process cartridge is rotated for a length of time equivalent to the printing of roughly 50,000 copies, the latent image formation process cartridge reaches the end of its service life. Further, the estimated length of time the photosensitive drum in a given latent image formation process cartridge has to rotated to print roughly 40,000 copies is used as the threshold value (first prewarning value) for issuing the first warning that the latent image formation process cartridge is near the end of its service life, and the estimated length of time the same photosensitive drum has to be rotated to print roughly 49,000 copies is used as the threshold value (second prewarning value) for issuing the second warning that the latent image formation process cartridge is near the end of its service life.

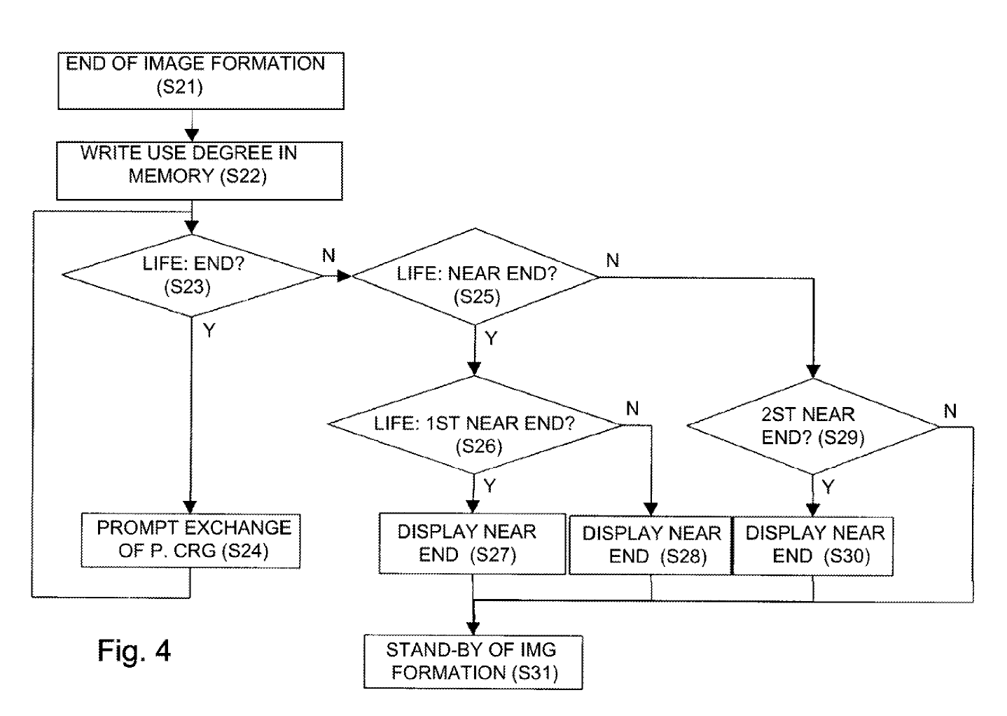

FIG. 4 shows the operational sequence for issuing the warning that the latent image formation process cartridge and/or development process cartridge are at or near the end of their service life.

Referring to FIG. 4, at the end of the formation of each image by the image forming apparatus 60 (S21), the extent of usage of each of the latent image formation process cartridges 20 (20a-20d) and development process cartridges 21 (21a-21d) is written into the corresponding information storage means 46 (46a-46d) and 47 (47a-47d) (S22). Then, it is checked whether or not each of the latent image formation process cartridges 20 (20a-20d) and each of the development process cartridges 21 (21a-21d) have reached the end of its service life (S23). If it is determined that one or more of the process cartridges are at the end of their service life, a user is informed that one or more of the process cartridges need to be replaced (S24). If it is determined that no process cartridge has reached the end of its service life, it is checked whether or not the extent of usage of any of the development process cartridges 20 (20a-20d) has reached the threshold value for informing a user that one or more development process cartridges 20 are near the end of their service life (S25). If any of the development process cartridges 20 is near the end of its service life, it is checked whether or not the extent of usage of any of the latent image formation process cartridges 21 (21a-21d) has reached the threshold value (first threshold value) for issuing a user the first warning that one or more latent image formation process cartridges 20 are near the end of their service life (S26). If the answer is YES, the warning that the development process cartridge is near the end of its service life, and the warning that the latent image formation process cartridge is near the end of its service life, are issued (S27). If the answer is No in S26, only the warning that the development process cartridge is near the end of its service life is issued (S28). Then, the image forming apparatus is readied for image formation (S31). If it is determined in S25 that the development process cartridge is not near the end of its service life, it is checked whether or not the extent of usage of any the latent image formation process cartridges has reached the threshold value (second threshold value) for issuing the second warning that the latent image forming process cartridge is near the end of its service life (S29). If the answer is YES, the warning that the end of service life is near is issued for the latent image formation process cartridges, which have reached the second threshold value in terms of the extent of usage (S30). If the answer is NO in S29, that is, no latent image formation process cartridge has reached the second threshold value in terms of extent of usage, the image forming apparatus is readied for image formation without the issuance of the warning (S31).

That is, the warning that a latent image formation process cartridge is near the end of its service life is issued along with the warning that a development process cartridge is near the end of its service life. In this embodiment, however, it is only if a latent image formation process cartridge has reached the second threshold value in terms of extent of usage that the warning that the latent image formation process cartridge is near the end of its service life is issued without issuance of the warning that the corresponding development process cartridge is near the end of its service life. Therefore, it does not occur that a latent image formation process cartridge reaches the end of its service life without the issuance of the warning that it is near the end of its service life. This setup is made in anticipation of such a situation that a development process cartridge in the main assembly of an image forming apparatus is replaced with a brand-new one before the end of its service life.

With the employment of this embodiment of the present invention, even in the case of an image forming apparatus which employs a substantial number of process cartridges which are removably mountable in the main assembly of the apparatus, the warning that a process cartridge is near the end of its service life is unlikely to be issued as frequently as in the case of any of the image forming apparatuses in accordance with the prior art. Therefore, in the case of the image forming apparatus in this embodiment, a user is not going to be required to carry out the operation for preparing replacement process cartridges, that is, an annoying operation to a user, as frequently as in the case of any of the conventional image forming apparatuses. Further, it is unlikely to occur that a process cartridge unexpectedly reaches the end of its service life without the issuance of the warning by an image forming apparatus that the process cartridge is near the end of its service life.

Incidentally, the process cartridge, in this embodiment, which has the first threshold value, that is, the threshold value for issuing the first warning that a process cartridge is near the end of its service life, and the second threshold value, that is, the threshold value for issuing the second warning that the same process cartridge is near the end of its service life (second extent of usage of process cartridge) was described with reference to a latent image formation process cartridge. However, this embodiment is also applicable to a case where both the latent image formation process cartridges and development process cartridges have the first and second threshold values described above, and the effects of the application are the same as those described above. That is, in this embodiment, a certain amount of latitude is provided in terms of the range of extent of usage, within which the warning that each unit is near the end of its service life is to be issued. If both the extent of usage of the latent image formation unit and the extent of usage of the development process cartridge unit reach the threshold value for issuing the warming that a unit is near the end of its service life, the warning regarding the imminent ending of service life is issued for both units. If it is only one of the two unit that has exceeded the second threshold value, all that is necessary is to issue the warning regarding the imminent ending of service life for the unit which has exceeded the second threshold value in terms of the extend of usage. The structural arrangement that provides both the latent image formation unit and development unit with the first and second threshold values is desirable in a case where there is no significant difference between a latent image formation process cartridge and the corresponding development process cartridge in terms of life expectancy.

Incidentally, in this preferred embodiment of the present invention, the warning that a process cartridge is near the end of its service life is issued, and then, the warning that the same process cartridge is at the end of its service life is issued. However, this embodiment is not intended to limit the present invention in scope. For example, the setup may be modified so that only the warning that a process cartridge is near the end of its service life is issued; the warning that the same process cartridge is at the end of its service life is not issued. Further, an image forming apparatus may be provided with a mode in which the warning that a process cartridge is at the end of its service life is issued after the issuance of the warning that the process cartridge is near the end of its service life, and a mode in which only the latter warning is issued (the former warning is not issued), so that a user is allowed to operate in the mode of his or her choice. In the case that the end of the service life is not issued, the end of the nominal service life is the limit of usability.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Applications Nos. 120679/2010 and 107397/2011 filed May 26, 2010 and May 12, 2011 which are hereby incorporated by reference.

What is claimed is:

1. An image forming apparatus comprising:
a main assembly;
a first unit detachably mountable to said main assembly and including means contributable to image formation;
a second unit constituting a pair with said first unit and including means contributable to the image formation, said second unit being detachably mountable to said main assembly;
a detecting device for detecting a degree of use of each of said first unit and said second unit,
wherein limits of usability are predetermined for said first unit and said second unit, respectively; and
a control device capable of outputting information signals for notifying states near the limits of usability on the basis of preset thresholds of degrees of use, respectively,
wherein when image formations are carries out under a predetermined image forming condition, a number of capable image formations from an output of the information signal indicating the near state for said first unit to the limit of usability of said first unit is larger than a number of capable image formations from an output of the information signal indicating the near state for said second unit to the limit of usability of said second unit, and
wherein said control device outputs the information signal for said second unit when the degree of use of said second unit reaches a second threshold of degree of use, and
said control device outputs the information signal for said first unit when a condition that the degree of use of said first unit reaches a first threshold of degree of use of said first unit and a condition that the degree of use of said second unit reaches a second threshold of degree of use are satisfied.

2. An apparatus according to claim 1, wherein said first unit is a latent image forming unit including an image bearing member for bearing an electrostatic latent image, and said second unit is a developing unit accommodating a developer for developing the electrostatic latent image.

3. An apparatus according to claim 1, wherein said apparatus comprises a plurality of such pairs, and is capable of full-color image formation, and said control device is capable of outputting the information signals, for said first units and second units of respective pairs.

4. An image forming apparatus comprising:
a main assembly;
a first unit detachably mountable to said main assembly and including a device contributable to image formation;
a second unit constituting a pair with said first unit and including a device contributable to the image formation, said second unit being detachably mountable to said main assembly;
a detecting device for detecting a degree of use of each of said first unit and said second unit,
wherein limits of usability are predetermined for said first unit and said second unit, respectively; and
a control device capable of outputting information signals for notifying states near the limits of usability on the basis of degrees of use, respectively,
wherein when image formations are carries out under a predetermined image forming condition, a number of capable image formations from an output of the information signal indicating the near state for said first unit to the limit of usability of said first unit is larger than a number of capable image formations from an output of the information signal indicating the near state for said second unit to the limit of usability of said second unit, and
wherein said control device changes timing of outputting the information signal for said first unit, in accordance with the degree of use of said second unit.

5. An apparatus according to claim 4, wherein for the degree of use of said first unit for determining the timing of outputting the information signal, a first threshold and a second threshold indicative of a larger degree of use than the first threshold are predetermined; said control device outputs the information signal for said second unit when said second unit reaches the second threshold of degree of use; before said second unit reaches the second threshold of degree of use, said control device outputs the information signal for said first unit when said first unit reaches the second threshold; and
after said second unit reaches the second threshold of degree of use, said control device outputs the information signal when said first unit reaches the first threshold.

6. An apparatus according to claim 4, wherein said first unit is a latent image forming unit including an image bearing member for bearing an electrostatic latent image, and said second unit is a developing unit accommodating a developer for developing the electrostatic latent image.

7. An apparatus according to claim 4, wherein said apparatus comprises a plurality of such pairs, and is capable of full-color image formation, and said control device is capable of outputting the information signals, for said first units and second units of respective pairs.
